(19) United States
(12) Patent Application Publication
(10) Pub. No.: US 2011/0028255 A1
(43) Pub. Date: Feb. 3, 2011

(54) Link Plate for a Bicycle Chain

(76) Inventor: Chih-Chung Chin, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/901,611

(22) Filed: Oct. 11, 2010

Related U.S. Application Data
(63) Continuation-in-part of application No. 12/057,388, filed on Mar. 28, 2008.

(51) Int. Cl. F16G 13/02

(52) U.S. Cl. 474/227

(57) ABSTRACT

A link plate for a bicycle chain includes an installation hole defined within a circumferential edge thereof The link plate further includes a ridge extending inwardly from a peripheral wall thereof and having a depth smaller than a depth thereof The installation hole defines first and second apertures. The second aperture extends immediately from the first aperture. Furthermore, the first aperture has a diameter “D1”, and the second aperture includes an upper portion having a diameter “D2” and a lower portion having a diameter “D3”. The diameter “D3” is smaller than the diameters “D1” and “D2”. Additionally, the ridge defines two peak portions disposed between the first and second apertures and spaced from each other by a first distance “d1”. The distance “d1” is smaller than the diameters “D1” and “D3”.

### CROSS REFERENCE

The present application is a continuation-in-part application of U.S. patent application Ser. No. 12/057,388, filed on Mar. 28 2008, of which the entire disclosure is incorporated herein.

### BACKGROUND OF THE INVENTION

1. Field of the Invention

The present invention relates to link plates for a bicycle chain, and particularly, to a link plate has a configuration that allows another link plate to join to it easily and prevents the connected link plate from disengagement from it as well as impedes a change in a pitch between two adjacent shafts of the two link plates.

2. Description of the Related Art

U.S. Publication No. 2007/0197333 shows two link plates are adapted to connect together. Each link plate includes an elongated hole for reception of a chain pin which extends from another link plate, thereby enabling two link plates connect together. The elongated hole of each link plate defines a larger diameter end, a smaller diameter end, and a displacement region therebetween. When connecting the two link plates together, the chain pin extending from one link plate is inserted into the larger diameter end of the elongated hole defined in the other link plate, and then the chain pin is urged through the displacement region into the smaller diameter end. When the chain pins associated with the two link plates are respectively retained in the smaller diameter end of the elongated hole the two link plates are connected to each other in a secure manner. It is, however, a complex task to manufacture each link plate. Therefore, it is still desirable to provide a link plate which has a simple structure, particularly, to a link plate including an elongated hole defining a larger diameter end and a smaller diameter end only, but can sufficiently prevent a chain pin engaged therein from moving from the smaller diameter end to the larger diameter end.

Additionally, U.S. Pat. No. 587950 shows a link plate including a hole for receiving a rivet which extends from another link plate in order to connect the two link plates together, and specifically, the rivet is inserted into the hole via a slot which extends from the hole and opens at a circumferential edge of the link plate in which the hole is defined. It is, however, a problem that the slot is liable to suffer elastic fatigue, since the slot that defines an open end at the circumferential edge of the link plate in which it defines has difficulty to resume its open end's cross sectional size after being expanded.

The present invention is, therefore, intended to obviate or at least alleviate the problems encountered in the prior art.

### SUMMARY OF THE INVENTION

According to the present invention, a link plate for a bicycle chain includes a longitudinal length defined from a first end to a second end. Furthermore, the link plate includes an installation hole defined within a circumferential edge and disposed adjacent to the first end thereof. Moreover, the link plate includes a ridge extending inwardly from a peripheral wall thereof and having a depth smaller than a depth thereof The installation hole defines first and second apertures. The second aperture extends immediately from the first aperture. Furthermore, the first aperture has a diameter “D1”, and the second aperture includes an upper portion having a diameter “D2” and a lower portion having a diameter “D3”. The diameter “D3” is smaller than the diameters “D1” and “D2”. Additionally, the ridge defines two peak portions disposed between the first and second apertures and spaced from each other by a first distance “d1”. The distance “d1” is smaller than the diameters “D1” and “D3”.

The link plate is connectable to another link plate and between which two shafts are disposed. Each shaft is engaged and retained in the second aperture of the installation hole of each link plate for connection of the two link plates. Furthermore, the shaft includes a groove portion and a head portion, and the groove portion has a diameter smaller than a diameter of the head portion.

Furthermore, the peak portions of the link plate have ability to be separated further apart that just allows the groove portion of the shaft to pass therethrough. Additionally, the peak portions of the link plate also have ability to resume the first distance therebetween.

It is therefore an object of the present invention to provide an assembly which includes two link plates connected together, and each link plate includes a shaft extending therefrom, with the two shafts cooperate to define a fixed pitch.

It is another object of the present invention to provide link plates that can be easily connected together.

Other objects, advantages, and new features of the present invention will become apparent from the following detailed description of the invention when considered in conjunction with the accompanied drawings.

### BRIEF DESCRIPTION OF THE DRAWINGS

FIG. 1 is an assembly including two of a plurality of link plates for a bicycle chain in accordance with a first embodiment of the present invention.

FIG. 2 is an exploded perspective view of the assembly shown in FIG. 1.

FIG. 3 is a side view of one link plate shown in FIG. 1.

FIG. 4 is a cross-sectional view taken along line 4-4 of the link plate shown in FIG. 1.

FIG. 5 illustrates a shaft extended from one link plate inserted in a first aperture of an installation hole defined in the other link plate.

FIG. 6 is a cross-sectional view taken along 6-6 of FIG. 5.

FIG. 7 is a continuous view of FIG. 5 and illustrates that the shaft extended from one link plate forced to pass through peak portions defined by a ridge, which is defined in the installation hole in the other link plate.

FIG. 8 is a continuous view of FIG. 7 and illustrates that the shaft extended from one link plate forced to pass through peak portions defined by a ridge, which is defined in the installation hole in the other link plate.

FIG. 9 is an enlarged view of FIG. 8.

FIGS. 10 is a continuous view of FIG. 8 and illustrates that the shaft extended from one link plate retained in a second aperture of the installation hole in the other link plate.

FIG. 11 is a cross-sectional view taken along line 11-11 of FIG. 10.

FIG. 12 is an assembly including two of a plurality of link plates for a bicycle chain in accordance with a second embodiment of the present invention.

FIG. 13 is a cross-sectional view taken along line 13-13 in FIG. 12.

FIG. 14 is an assembly including two of a plurality of link plates for a bicycle chain in accordance with a third embodiment of the present invention.

FIG. 15 is a cross-sectional view taken along line 15-15 in FIG. 14.

### DETAILED DESCRIPTION OF THE PREFERRED EMBODIMENT

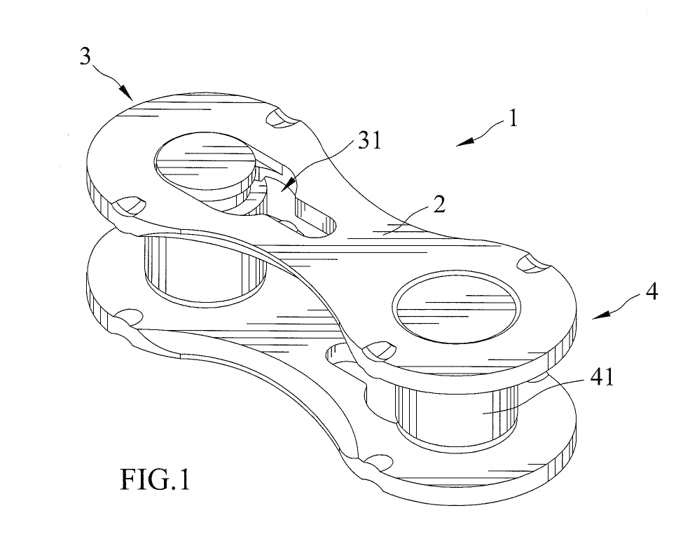

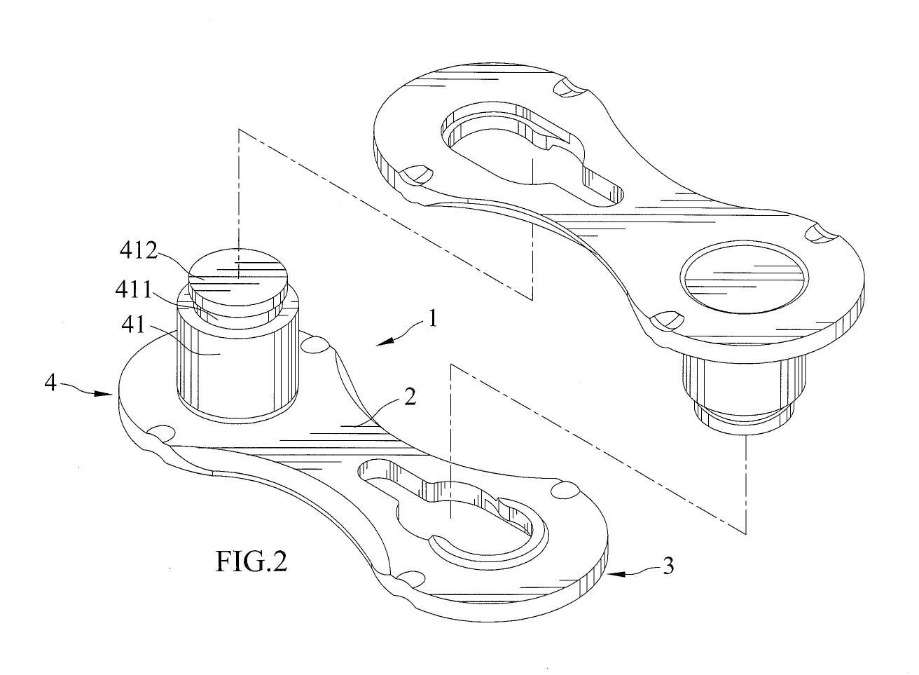

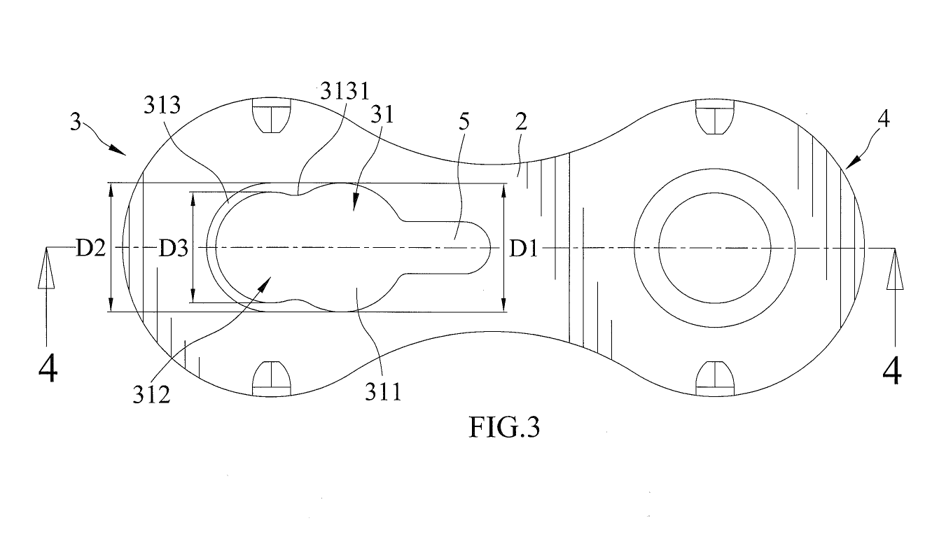

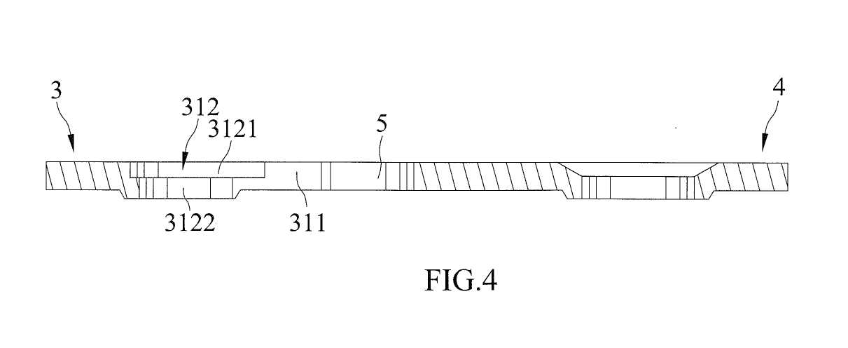

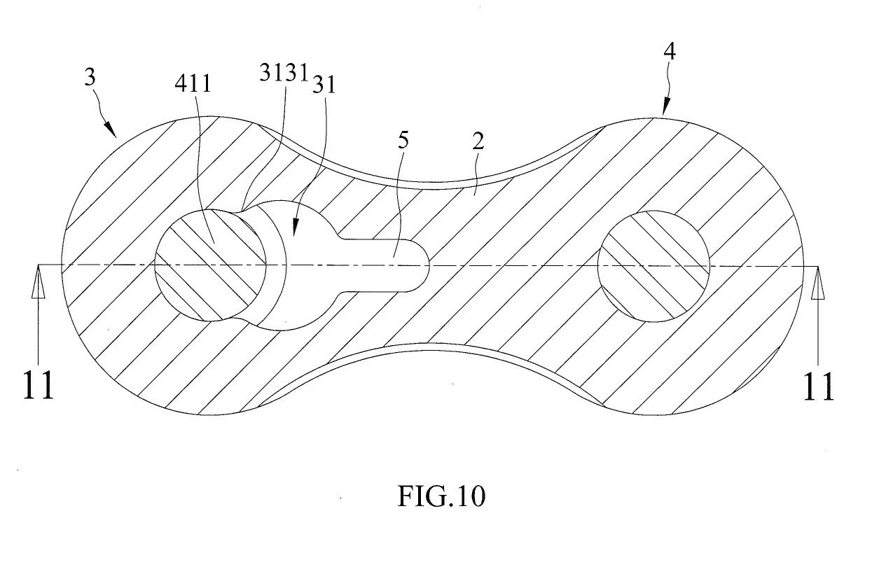

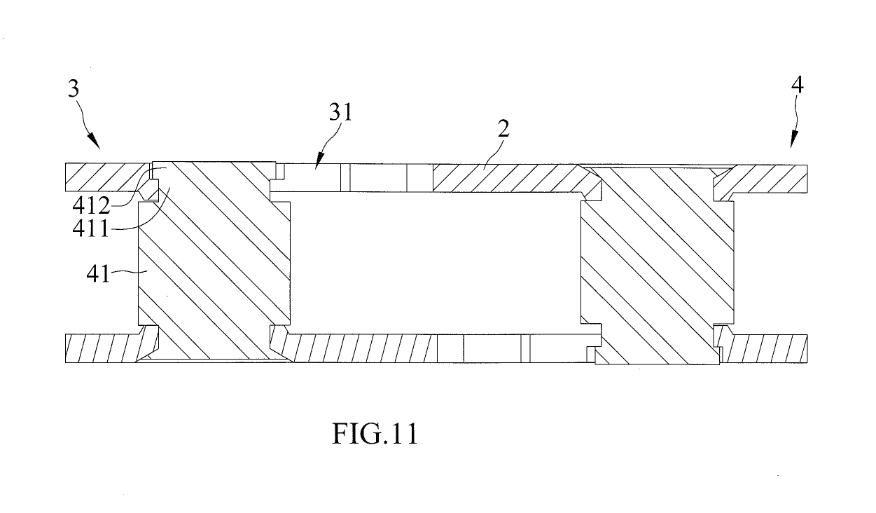

FIGS. 1 through 11 show an assembly 1 including two of a plurality of link plates 2 for a bicycle chain in accordance with a first embodiment of the present invention. The two link plates 2 are connected to each other with one opposite to the other.

Each link plate 2 defines two opposing ends along a longitudinal length thereof including a first end 3 and a second end 4, and an intermediate section (not numbered) between the first and second ends 3 and 4. In the preferred embodiment, the intermediate section has an increased width towards the first end 3 and/or the second end 4 of each link plate 2. Furthermore, each link plate 2 includes an installation hole 31 and a shaft 41. The installation hole 31, which is defined in each link plate 2, extends transversely to the longitudinal length and therethrough and is disposed within a circumferential edge of the link plate 2 as well as on the left side of a line C_{L} which extends transversely to the longitudinal length of the link plate 2 and divides it equally. Furthermore, the installation hole 31 of each link plate 2 includes a ridge 313 extending inwardly from a peripheral wall which delimits the installation hole 31 and having a depth smaller than that of the installation hole 31 such that the installation hole 31 defines a first aperture 311 and a second aperture 312, in which the first aperture 311 has a diameter “D1” and the second aperture 312 is in the form of a countersink hole which includes an upper portion 3121 with a diameter “D2” and a lower portion 3122 with a diameter “D3” smaller than the diameters “D1” and “D2”. The first and second apertures 311 and 312 of the installation hole 31 of each link plate 2 extend through the link plate 2 individually, and the second aperture 312 extends immediately from the first aperture 311 towards the first end 311 of the link plate 2, and in addition, two opposite points of the ridge 313, referred to as peak portions 3131, defined between the first and second apertures 311 and 312 is spaced from each other by a distance “d1”, which is smaller than the diameters “D1” and “D3”. In addition, the shaft 41, which is mounted to each link plate 2, extends transversely to the longitudinal length of the link plate 2. Furthermore, the shaft 41 of each link plate 2 is disposed on the right side of the line C_{L} and includes an end which is opposite to an end that contacts with the link plate 2 defining a groove portion 411 and a head portion 412, in which the groove portion 411 has a diameter “D4” greater than the distance “d1” and smaller than the diameter “D2” while the head portion 412 has a diameter “D5” greater than the diameter “D4” as well as the diameters “D2” and “D3” and substantially equal to or smaller than the diameter “D1”. Each link plate 2 further includes a slot 5 extending therethrough and from the first aperture 311 and disposed opposite to the second aperture 312 as well as within the circumferential edge of the link plate 2. Furthermore, the slot 5 of each link plate 2 defines an opening (not numbered) allowing it to communicate with the first aperture 311, which has a cross-sectional size “d2”. In the preferred embodiment, the slot 5 is elongated.

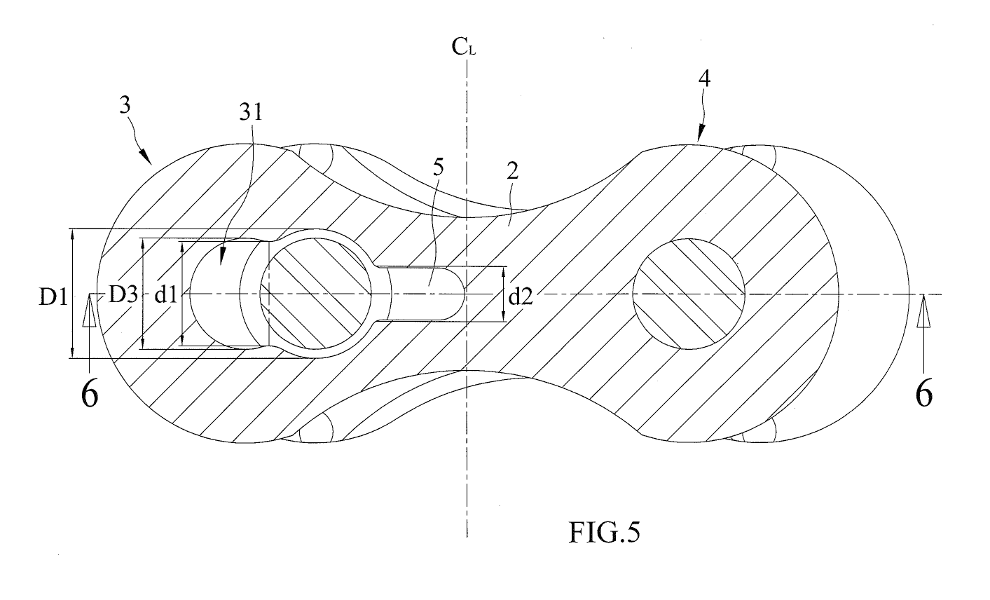

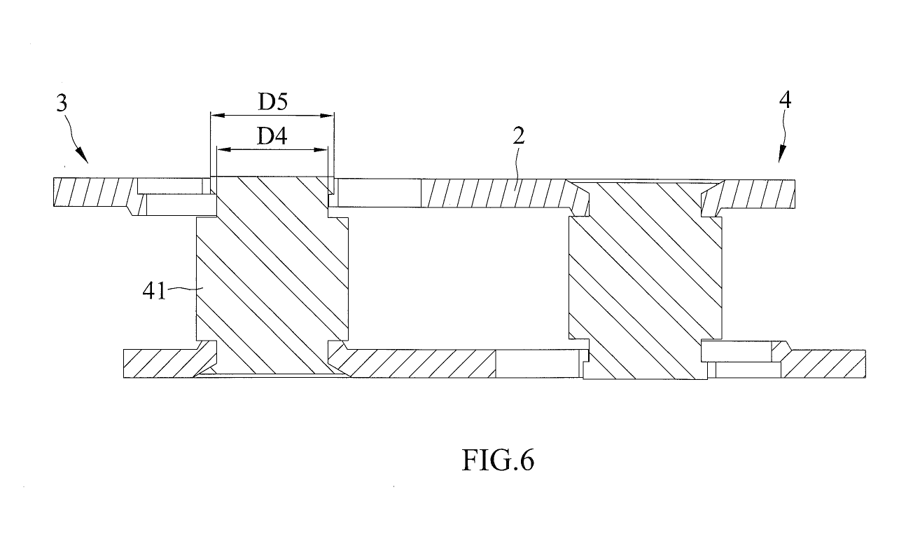

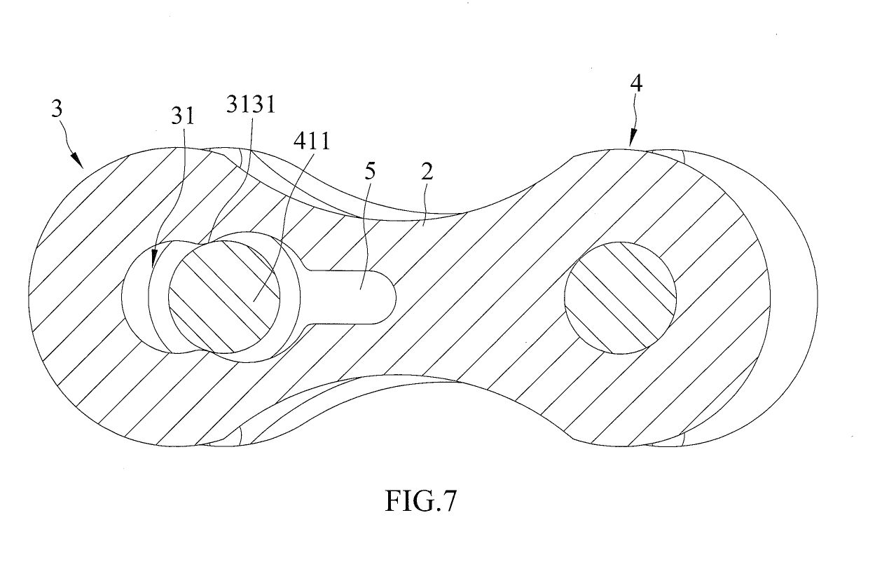

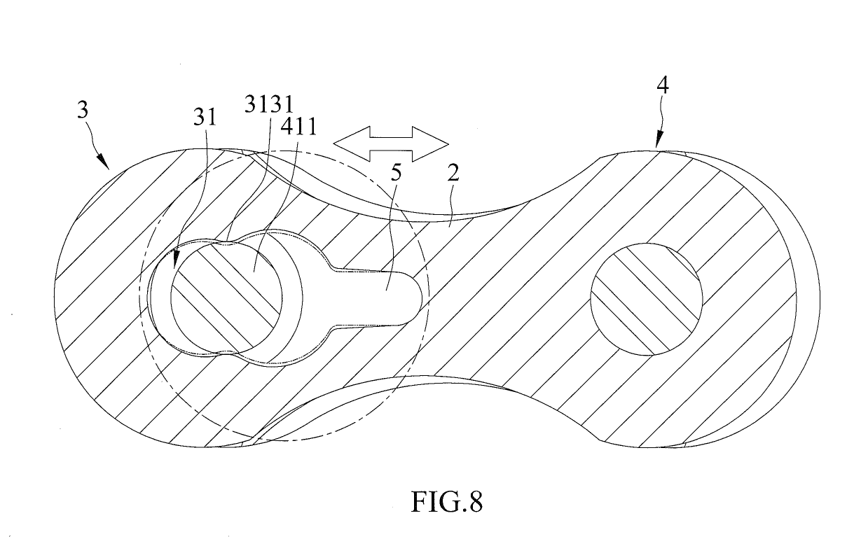

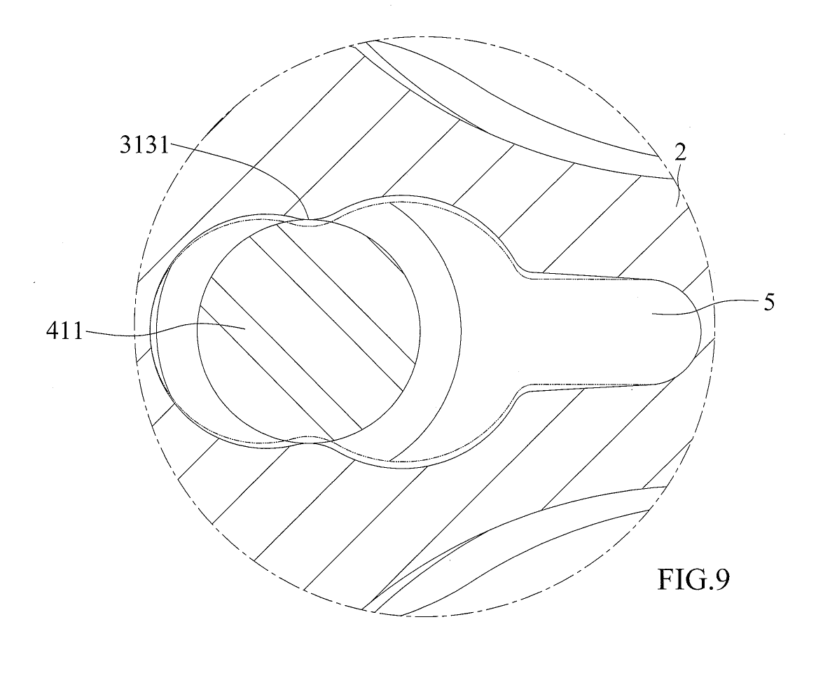

When the two link plates 2 are connected to each, the shaft 41 on each link plate 2 is retained in the second aperture 312 of the installation hole 31 defined in other link plate 2, with the head portion 412 retained in the upper portion 3121 as well as abutted against the ridge 313, with groove portion 411 retained in the lower portion 3122, and with the ridge 313 received in the groove portion 411. Because the diameter “D4” is greater than the distance “d1”, each shaft 41 is prevented from disengagement from the second aperture 312 of the installation hole 31 it engages in to connect the two link plates 2 together in a manner that they are prevented from moving relative to each other and to accomplish an object that the shafts 41 thereof define a fixed pitch. So, to connect the two link plates 2 in the manner as set forth, an initial step is inserting the shaft 41 on one link plate 2 into the installation hole 31 of the other link plate 2 (as best seen in FIGS. 5 and 6), then the two link plates 2 are moved oppositely to force each shaft 41 to move from the first aperture 311 to the second aperture 312 of the installation hole 31 it engages in (as best seen in FIGS. 7 through 11). Each shaft 41 is adapted to have its groove portion 411 and head portion 412 inserted into the first aperture 311 of the installation hole 31 it engages in when being inserted into the first aperture 311 of the installation hole 31, because the diameter “D1” is greater than the diameters “D4” and “D5”. In order to move each shaft 41 from the first aperture 311 to the second aperture 312 of the installation hole 31 it engages in, the groove portion 411 thereof, which is of a diametrical size small enough to be forced through the peak portions 3131 of the ridge 313 therein, is forced through a space between the peak portions 3131, which have ability to be separated further apart that just allows the groove portion 411 to pass therethrough, as best seen in FIGS. 8 and 9. Additionally, each shaft 41 not only causes the peak portions 3131 of the ridge 313 defined in the installation hole 31 it engages to separate further but also causes the slot 5 connected with the installation hole 31 to have its opening expanded, thus facilitating the shaft 41 to pass through the peak portions 3131. Furthermore, the peak portions 3131 of the ridge 313 of each installation hole 31 resume their original separated distance, “d1”, and the opening of each related slot 5 resumes its original cross-sectional size, “d2”, after the shaft 41 engaged in that installation hole 31 is retained in the second aperture 312.

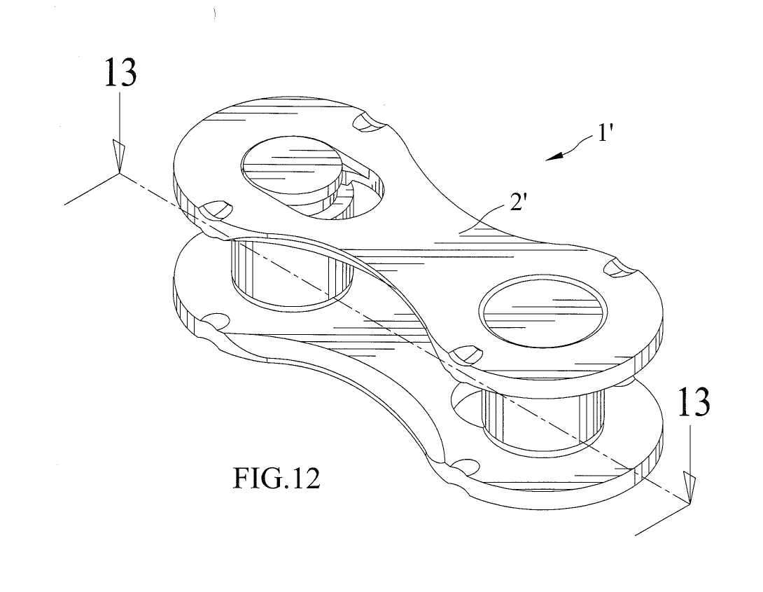

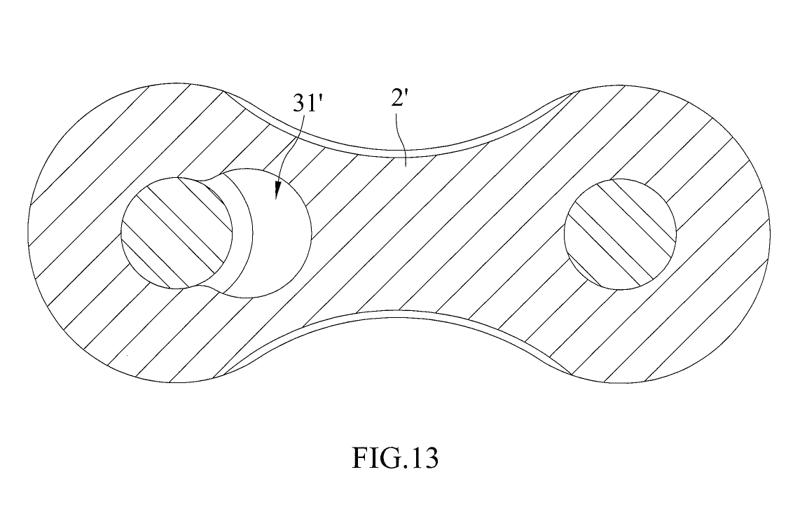

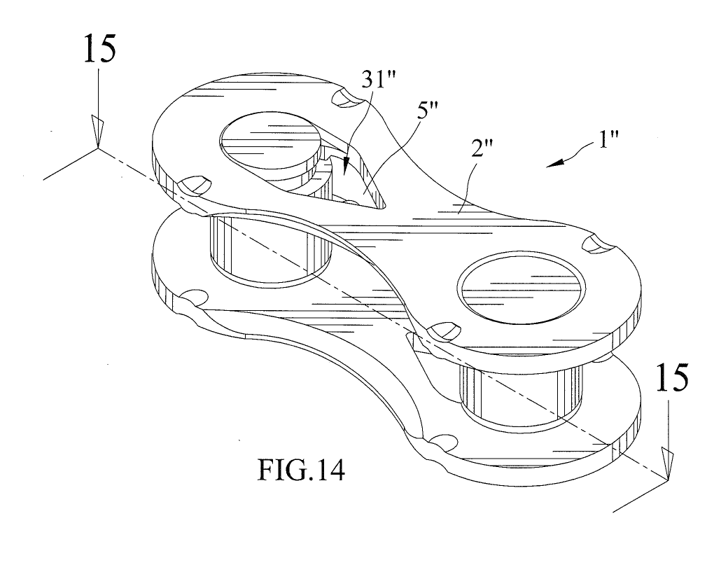

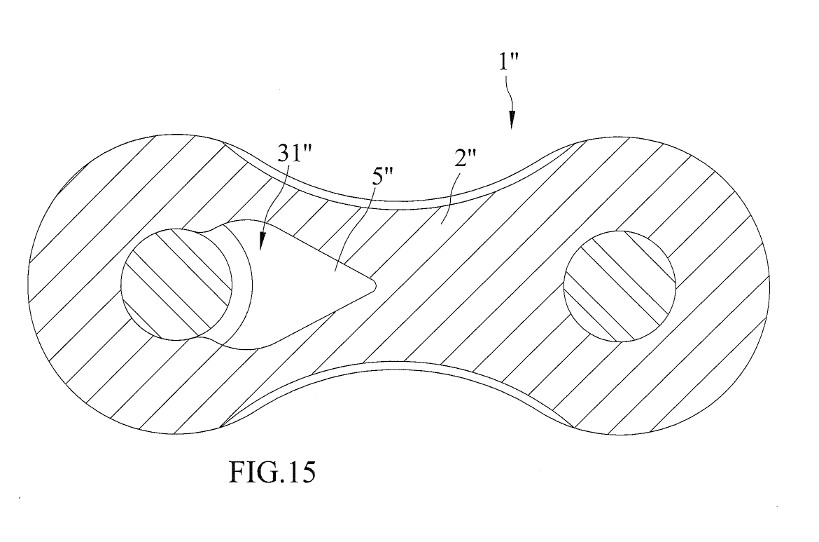

FIGS. 12 and 13 show an assembly 1′ including two of a plurality of link plates 2′ in accordance with a second embodiment of the present invention, wherein like number is used to denote the same or similar part, except bearing a prime. Each link plate 2′ is modified from each link plate 2 and the modification is that the slot 5 is eliminated. FIGS. 14 and 15 show an assembly 1″ including two of a plurality of link plates 2″ in accordance with a third embodiment of the present invention, wherein like number is used to denote the same or similar part, except bearing a double prime. Each link plate 2″ is modified from each link plate 2 and the modification is that the slot 5 is replaced by a slot 5″, which has a different configuration. In this preferred embodiment, the slot 5″ in each link plate 2″ has an outline which is substantially triangular.

In view of the forgoing, each assembly 1, 1′ and 1″ has two link plates 2, 2′ and 2″ that can be easily connected together and without the aid of tools. Further, the shafts 41 extended from each link plate 2 cooperate to define a pitch, and each shaft 41 is prevented from disengaging inadvertently from the second aperture 312 of the installation hole 31 it engages in, thereby sustaining a fixed pitch. Therefore, cogs for engaging with a bicycle chain which is made of a plurality of assemblies 1 or 1 ‘or 1″ in accordance with the present invention will not suffer a problem that their teeth can not properly engage with any of the plurality of assemblies 1, 1’ and 1″.

While the specific embodiments have been illustrated and described, numerous modifications come to mind without significantly departing from the spirit of invention, and the scope of invention is only limited by the scope of the accompanying claims.

What is claimed is:

1. A link plate for a bicycle chain comprising:
a longitudinal length defined from a first end to a second end; and
an installation hole defined within a circumferential edge and disposed adjacent to the first end of the link plate as well as including a ridge extending inwardly from a peripheral wall thereof and having a depth smaller than a depth thereof such that the installation hole defines first and second apertures, with the second aperture extending immediately from the first aperture, with the first aperture having a first diameter, with the second aperture including an upper portion having a second diameter and a lower portion having a third diameter, with the third diameter smaller than the first and second diameters, with the ridge further defining two peak portions disposed between the first and second apertures and spaced from each other by a first distance, with the first distance smaller than the first and third diameters; and
wherein the link plate is connectable to another link plate and between which two shafts are disposed, with each shaft engaged and retained in the second aperture of the installation hole of each link plate, with the shaft including a groove portion and a head portion, with the groove portion having a diameter smaller than a diameter of the head portion, with the peak portions of the link plate having ability to be separated further apart that just allows the groove portion of the shaft to pass therethrough, with the peak portions of the link plate also having ability to resume the first distance therebetween.

2. The link plate as claimed in claim 1 further comprising a slot defined within the circumferential edge thereof and extending from the first aperture as well as disposed opposite to the second aperture, with the slot further defining an opening communicating with the first aperture.

3. The link plate as claimed in claim 2 wherein the slot is elongated.

4. The link plate as claimed in claim 2 wherein the slot has a triangular outline.

5. The link plate as claimed in claim 1 wherein the installation hole is disposed on a side of a line which extends transversely to the longitudinal length of the link plate and divides it equally.

6. The link plate as claimed in claim 2 wherein the installation hole and the slot are disposed on a side of a line which extends transversely to the longitudinal length of the link plate and divides it equally.

7. The link plate as claimed in claim 5 wherein each shaft is disposed on a side of a line which is opposite to the installation hole.
